(19) United States
(12) Patent Application Publication
(10) Pub. No.: US 2017/0164016 A1
(43) Pub. Date: Jun. 8, 2017

(54) DATA TRANSFER METHOD AND DEVICE

(71) Applicants: LE HOLDINGS (BEIJING) CO., LTD., BEIJING (CN); LE SHI ZHI XIN ELECTRONIC TECHNOLOGY (TIANJIN) LIMITED, TIANJIN (CN)

(72) Inventor: Xing YANG, Tianjin (CN)

(21) Appl. No.: 15/245,104

(22) Filed: Aug. 23, 2016

Related U.S. Application Data
(63) Continuation of application No. PCT/CN2016/089279, filed on Jul. 7, 2016.

(30) Foreign Application Priority Data
Dec. 3, 2015 (CN) 201510885364.7

(51) Int. Cl. H04N 21/2343; H04N 21/234; H04N 21/643; H04N 21/44; H04N 21/2187; H04N 21/4223

(52) U.S. Cl. CPC H04N 21/2343; H04N 21/2187; H04N 21/4223; H04N 21/64322; H04N 21/44; H04N 21/23418

(57) ABSTRACT

An embodiment of the present disclosure discloses a data transfer method and device. The data transfer method comprises: receiving live data streams sent by at least two camera devices, wherein the live data streams are sent after being coded by the camera devices according to a first protocol; performing protocol conversion on each of the live data streams and obtaining converted live data streams; and uploading the converted live data streams to a live server at the same time. Therefore, the live data streams of a plurality of camera devices can be transferred through a router, and live video communication is more diversified.

### CROSS-REFERENCE TO RELATED APPLICATIONS

This application is a continuation of International Application No. PCT/CN2016/089279 filed on Jul. 7, 2016, which is based upon and claims priority to Chinese Patent Application No. 201510885364.7, entitled “DATA TRANSFER METHOD AND DEVICE”, filed on Dec. 3, 2015, the entire contents of all of which are incorporated herein by reference.

### TECHNICAL FIELD

The present disclosure generally relates to the technical field of Internet, in particular to a data transfer method and device.

### BACKGROUND

Except for the image capturing function of common traditional cameras, IP Cameras can transport live video and audio through the Internet or an internal local area network.

During the process of realizing the present disclosure, the inventor found that, at present, some manufacturers carry out direct communication with their own servers and send control commands through IP Cameras. Some manufacturers employ a P2P mode, meaning that live terminals perform direct control operations on the IP Camera. Such communication mode needs a point-to-point connection between the live terminals and the IP Camera.

However, the live video communication usually occurs during interaction between a single device and the server, and the live video communication is singular.

### SUMMARY

The technical problem to be solved in the embodiment of the present disclosure is to disclose a data transfer method for solving the problem of complicated video communication.

Correspondingly, an embodiment of the present disclosure further discloses a data transfer device for ensuring the realization and application of the method above.

To solve the problem above, an embodiment of the present disclosure discloses a data transfer method, comprising:

receiving live data streams sent by at least two camera devices, wherein the live data streams are sent after being coded by the camera devices according to a first protocol;

performing protocol conversion on each of the live data streams and obtaining converted live data streams;

and uploading the converted data streams to a live server at the same time.

An embodiment of the present disclosure further discloses an electronic device for data transfer, the electronic device comprising at least one processor; and a memory communicably connected with the at least one processor for storing instructions executable by the at least one processor, wherein execution of the instructions by the at least one processor causes the at least one processor to:

receive live data streams sent by at least two camera devices, wherein the live data streams are sent after being coded by the camera devices according to a first protocol;

perform protocol conversion on each of the live data streams and obtain converted live data streams;

upload the converted live data streams to a live server at the same time.

An embodiment of the present disclosure discloses a non-transitory computer readable medium storing executable instructions that, when executed by an electronic device, cause the electronic device to execute the data transfer method above.

Compared with the prior art, the embodiment of the present disclosure has the following advantages of receiving live data streams sent by at least two camera devices, performing protocol conversion on each of the live data streams, obtaining converted live data streams, and uploading the converted live data streams to a live server at the same time. Therefore, the live data streams of a plurality of camera devices can be transferred through a router, and live video communication is more diversified.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a data transfer method in accordance with some embodiments.

FIG. 2 is a step flowchart of a data transfer method in accordance with some embodiments.

FIG. 3 is a step flowchart of a play method of live data streams in accordance with some embodiments.

FIG. 4 is a structural block diagram of a data transfer device in accordance with some embodiments.

FIG. 5 is a structural block diagram of a data transfer device in accordance with some embodiments.

FIG. 6 schematically illustrates a block diagram of an electronic device for executing the method in accordance with some embodiments.

FIG. 7 schematically illustrates a storage unit for holding or carrying program codes for realizing the method in accordance with some embodiments.

### DETAILED DESCRIPTION

To clarify the objectives, technical solutions and advantages of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

A core concept of the embodiment of the present disclosure is that the present disclosure provides a data transfer method which includes steps of receiving living data streams sent by at least two camera devices, performing protocol conversion on each of the live data streams, obtaining converted live data streams, and uploading the converted data streams to a live server at the same time. Therefore, the live data streams of a plurality of camera devices can be transferred through a router, and live video communication is more diversified.

Current families, malls, etc. usually have needs in live video play such as monitoring through camera devices, or have needs in live network play through camera devices. For example, a user monitors daily household situations through devices like IP Camera and TV camera, and a plurality of camera devices can meet the needs in multi-angle and omnibearing monitoring. In such case, the user needs to acquire the photographed images in real time which are synchronously transferred to the user through a network. Therefore, the embodiment of the present disclosure realizes the synchronous transport of the live data streams of the different camera devices through a router.

### Embodiment 1

A data transfer method according to an embodiment of the present disclosure is described in detail.

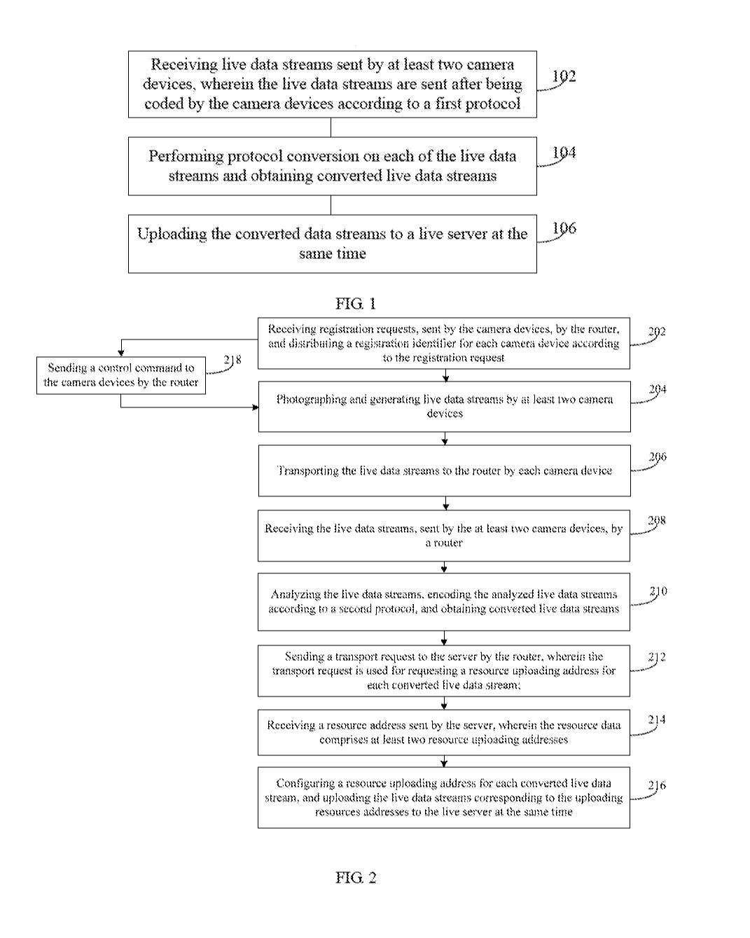

Refer to FIG. 1, which illustrates a step flowchart of a data transfer method according to an embodiment of the present disclosure. The method may specifically include the following steps.

Step S102: Receiving live data streams sent by at least two camera devices, wherein the live data streams are sent after being coded by the camera devices according to a first protocol.

The camera devices in the embodiment of the present disclosure refer to terminal devices with real-time photographing function, and the camera devices can transport live video and audio through the Internet or an internal local area network. Therefore, the camera devices can include IP Cameras, for example cameras with a network communication function, and can also include devices such as smart mobile phones, smart TVs and tablet computers with cameras.

At least two camera devices photograph in real time, generate live video data, encode the live video data according to a first protocol, for example the RTP (Real-time Transport Protocol), and generate live data streams. The camera devices transport the live data streams to the router. Wherein, RTP is a network transport protocol, describing standard data packet formats for transport of audio and video on the Internet in detail. The router receives the live data streams sent by the at least two camera devices.

Step S104: Performing protocol conversion on each of the live data streams and obtaining converted live data streams.

The live server only receives data encoded according to a specific protocol, while the first protocol employed in the embodiment of the present disclosure does not belong to the scope of the specific protocol, so the router needs to perform protocol conversion on each live data stream after receiving the live data streams sent by the at least two camera devices. In order to ensure the synchronization of the live data streams, the router can perform protocol conversion on all live data streams at the same time, and obtain the converted live data streams.

Step S106: Uploading the converted data streams to a live server at the same time.

Through protocol conversion, the server can receive the converted live data streams. In order to ensure the synchronization of the live data streams, the live data streams converted by the router are uploaded to the live server at the same time. The live terminal can acquire needed live data streams from the live server through the router, and play corresponding live videos.

In conclusion, the embodiment of the present disclosure has the advantages of receiving live data streams sent by at least two camera devices, performing protocol conversion on each of the live data streams, obtaining converted live data streams, and uploading the converted data streams to a live server at the same time. Therefore, the live data streams of a plurality of camera devices can be transferred through a router, and live video communication is more diversified.

### Embodiment 2

A data transfer method according to another embodiment of the present disclosure is described in detail. The camera devices and the router used in the embodiment of the present disclosure follow the ONVIF protocol, wherein the ONVIF protocol is a global open interface standard. The interface standard can ensure communication of network video products produced by different manufacturers. The camera devices and the router realize communication with devices in the ONVIF protocol respectively through the SDK (Software Development Kit) of the camera devices and the SDK of the router.

Refer to FIG. 2, which illustrates a step flowchart of a data transfer method according to another embodiment of the present disclosure. The method may specifically include the following steps.

Step S202: Receiving registration requests, sent by the camera devices, by the router, and distributing a registration identifier for each camera device according to the registration request.

Before transporting data with the router, the camera devices need to registration at the router and establish connections with the router. The router receives the registration requests sent by the camera devices, and distributes a registration identifier for each camera device according to the registration request, for example an IP (Internet Protocol) address. The router can distinguish different camera devices according to the registration identity.

Step S204: Photographing and generating live data streams by at least two camera devices.

Step S206: Transporting the live data streams to the router by each camera device.

At least two camera devices photograph in real time and generate live video data, and then the SDK of the camera devices encodes the live video data according to a first protocol, for example the RTP (Real-time Transport Protocol), and generates live data streams. The camera devices transport the live data streams to the router. The SDK of the camera device can transport the videos photographed in real time through the RTP, and store the photographed videos, usually in MP4 format. This process can be achieved by two processes, for example a writer, at the same time: one writer performs transport through the RTP, namely transporting the live data stream, and the other writer stores the photographed videos, namely photographing and generating the live data streams.

Step S208: Receiving live data streams sent by at least two camera devices by the router, wherein the live data streams are sent after being coded by the camera devices according to a first protocol.

Step S210: Analyzing the live data streams, encoding the analyzed live data streams according to a second protocol, and obtaining converted live data streams.

The router receives the live data streams sent by the at least two camera devices through the SDK thereof In the embodiment of the present disclosure, the server can receive the data encoded according to specific protocols, wherein, the specific protocols include RTMP (Real-time Messaging Protocol) or HLS (Http Live Streaming) network transport protocol. The two protocols are both open protocols capable of transporting audios, videos and data with the server in real time. However, the first protocol employed in the embodiment of the present disclosure does not belong to the scope of the specific protocol, so the router needs to decode each live data stream through the SDK thereof after receiving the live data streams sent by the at least two camera devices, and then acquire the live data. Then, the router encodes each live data according to the second protocol to realize protocol conversion. In order to ensure the synchronization of the live data streams, the router can perform protocol conversion on all live data streams, and obtain the converted live data streams.

Step S212: Sending a transport request to the server by a router, wherein the transport request is used for requesting a resource uploading address for each converted live data stream.

Step S214: Receiving a resource address sent by the server, wherein the resource data includes at least two resource uploading addresses.

The SDK of the router needs to determine the resource uploading address before sending data to the server. The SDK of the router sends a transport request to the server, wherein the transport request is used for requesting a resource uploading address for each converted data stream. The SDK of the router receives the resource address sent by the server, wherein the resource address includes at least two resource uploading addresses. Here, the resource addresses include URL (Uniform Resource Locator).

Step S216: Configuring a resource uploading address for each converted live data stream, and uploading the live data streams corresponding to the uploading resources addresses to the live server at the same time.

With at least two converted live data streams, in order to distinguish different converted live data streams during transport and during the subsequent acquisition process, the SDK of the router needs to distribute a resource uploading address to each converted live data stream. The live data streams corresponding to the uploading resources addresses are uploaded to the server at the same time according to the resource uploading address. In order to ensure the synchronization of the transport of the converted live data streams, the embodiment of the present disclosure employs a way of performing the protocol conversion on the data streams and transporting the data streams to different resource uploading addresses, such as the URL, representing different live input streams transferred to the live server, and the live server supplies the live services according to a plurality of live data streams.

Step S218: Sending a control command to the camera devices, wherein the control command includes a lifting command and/or a steering command.

In this embodiment, the camera devices can include IP Cameras, and the IP Camera can usually rotate 360° to change the photographing angle. The SDK of the router can find the corresponding IP Camera according to the registration address of the IP Camera, for example an IP address and send a control command to the IP Camera to change the photographing angle of the IP Camera, and the control command include a lifting command and/or a steering command. The camera device receives the control command, and executes the control command, namely executing an operation of lifting a camera or steering a camera for adjusting the photographing angle to adjust the video photographing angle, so the adjustment to the photographing angle can be made in a real time during remote monitoring, and then the video images monitored at different positions can be seen.

Besides, the resource addresses also include a public resource address, and the live terminal can play the corresponding live data stream according to the public network resource address.

Refer to FIG. 3, which illustrates a step flowchart of a method for playing live data stream according to an embodiment of the present disclosure. The method may specifically include the following steps.

Step 302: Sending the public network resource address to a live terminal so that the live terminal plays the live data stream corresponding to the public network resource address.

The resource address received by the SDK of the router from the server also includes the public network resource address, and the public network resource address is the resource address of the server for the outside world, for example an outside URL. This means that, the live terminal can play the corresponding live data stream according to the public network resource address. The public network resource address is sent to a live terminal, and then the live terminal plays the live data stream corresponding to the public network resource address. The live terminal can also send the public network resource address to another live terminal, and another live terminal can obtain the shared live video through the public network resource address.

Step S304: Receiving a switching request sent by the live terminal, wherein the switching request includes a registration identifier of a target camera device.

Step S306: Stopping acquiring the live data stream of the current camera device according to the registration identifier of the target camera device and switching to the target camera device to acquire the live data stream.

Step S308: Feeding back the live data stream of the target camera device to the live terminal.

Different camera devices vary with positions and device performance, the live terminal may have a need to play a video photographed by another target camera device when playing a video photographed by a certain camera device, for example, when the live terminal plays a video photographed by a mobile phone Camera, the live terminal can send a request for switching a camera device to the router when needing to switching to the video photographed by an IP Camera because the scope photographed by the mobile phone Camera is relatively small. Wherein, the switching request includes a registration identifier of a target camera device, for example an IP address. The embodiment of the present disclosure stops acquiring the live data stream of the current camera device according to the registration identifier of the target camera device for example the IP address of the target camera device, switches to the target camera device to acquire the live data stream, and feeds back the live data stream of the target camera device to the live terminal. The live terminal plays the live data stream of the target camera device.

In conclusion, the embodiment of the present disclosure has the advantages of receiving the switching request sent by the live terminal through the router, stopping acquiring the live data stream of the current camera device according to the register identifier of the target camera device, switching to the target camera device to acquire the live data stream, and feeding back the live data stream of the target camera device to the live terminal. The live terminal plays the live data stream of the target camera device, realizing the live terminal's function of switching the camera devices.

It is needed to be noted that, for simple description, the method embodiments are described as a series of action combinations, but a person skilled in the art understands that the embodiments of the present disclosure are not limited by the sequence of the described actions because according to the embodiments of the present disclosure, some steps can be implemented in other sequences or at the same time. Moreover, a person skilled in the art also should understand that the embodiments described in the present disclosure all belong to optimal embodiments, and some actions involved are not always needed by the embodiments of the present disclosure.

### Embodiment 3

A data transfer device according to an embodiment of the present disclosure is described in detail.

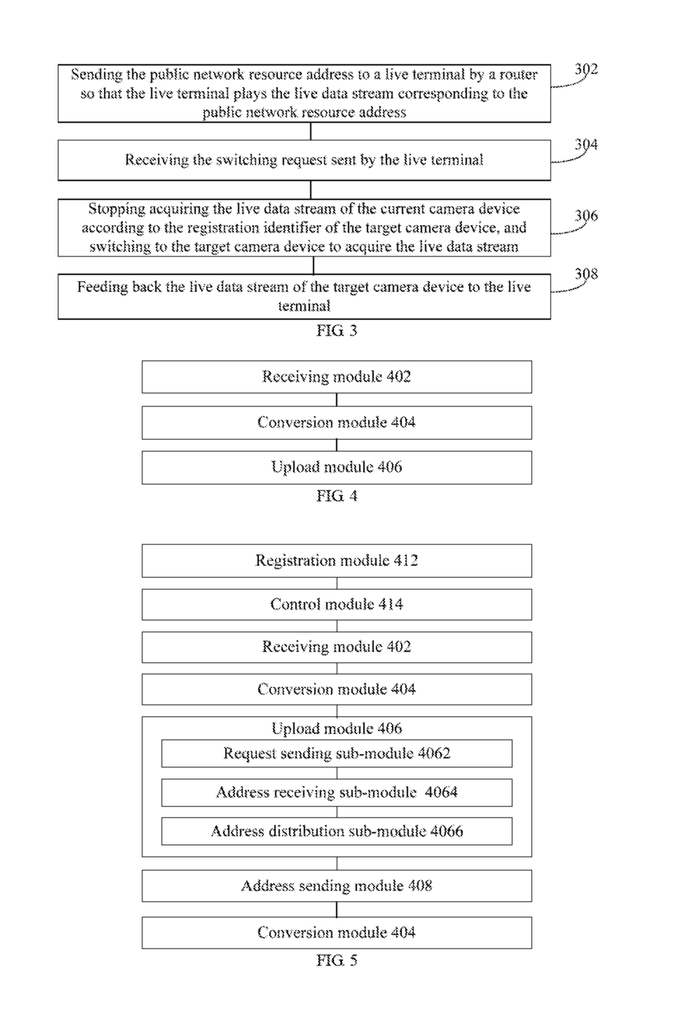

Refer to FIG. 4, which illustrates a structural block diagram of a data transfer device according to an embodiment of the present disclosure. The device can specifically include the following modules: a receiving module 402, a conversion module 404 and an upload module 406.

The receiving module 402 is used for receiving live data streams sent by at least two camera devices, wherein the live data streams are sent after being coded by the camera devices according to a first protocol.

The conversion module 404 is used for performing protocol conversion on each of the live data streams and obtaining converted live data streams.

The upload module 406 is used for uploading the converted live data streams to a five server at the same time.

In conclusion, the data transfer device receives live data streams sent by at least two camera devices, performs protocol conversion on each of the live data streams, obtains converted live data streams, and uploads the converted live data streams to a live server at the same time. Therefore, the live data streams of a plurality of camera devices can be transferred through a router, and live video communication is more diversified.

### Embodiment 4

A data transfer device according to another embodiment of the present disclosure is described in detail.

Refer to FIG. 5, which illustrates a structural block diagram of a data transfer device according to another embodiment of the present disclosure. The device can specifically include the following modules: a registration module 412, a control module 414, a receiving module 402, a conversion module 404, an upload module 406, an address sending module 408 and a switching module 410.

The registration module 412 is used for receiving registration requests, sent by the camera devices, by the router, and distributing a registration identifier for each camera device according to the registration request.

The control module 414 is used for sending a control command to the camera devices, wherein the control command includes a lifting command and/or a steering command.

The receiving module 402 is used for receiving live data streams sent by at least two camera devices, wherein the live data streams are sent after being coded by the camera devices according to a first protocol.

The conversion module 404 is used for analyzing the live data streams, encoding the analyzed live data streams according to a second protocol, and obtaining converted live data streams.

The upload module 406 is used for uploading the converted live data streams to a live server at the same time.

Wherein, the upload module 406 includes a request sending sub-module 4062, an address receiving sub-module 4064 and an address distribution sub-module 4066.

The request sending sub-module 4062 is used for sending a transport request to the server by a router, wherein the transport request is used for requesting a resource uploading address for each converted live data stream.

The address receiving sub-module 4064 is used for receiving a resource address sent by the server, wherein the resource address includes at least two resource uploading addresses.

The address distribution sub-module 4066 is used for configuring a resource uploading address for each converted live data stream, and uploading the live data streams corresponding to the uploading resources addresses to the live server at the same time.

The address sending module 408 is used for sending the public network resource address to a live terminal so that the live terminal plays the live data stream corresponding to the public network resource address.

The switching module 410 is used for receiving a switching request sent by the live terminal, wherein the switching request includes a registration identifier of a target camera device; stopping acquiring the live data stream of the current camera device according to the registration identifier of the target camera device, and switching to the target camera device to acquire the live data stream; and feeding back the live data stream of the target camera device to the live terminal.

In conclusion, the data transfer device receives the switching request sent by the live terminal through the router, stops acquiring the live data stream of the current camera device according to the register identifier of the target camera device and switches to the target camera device to acquire the live data stream; and the data transfer device feeds back the live data stream of the target camera device to the live terminal. The live terminal plays the live data stream of the target camera device, realizing the live terminal's function of switching the camera devices.

The device embodiment is basically the same as the method embodiments and therefore is simply described. Related contents can be seen in the related description of the method embodiments.

All embodiments of the present disclosures are described in a progressive manner. Every embodiment focuses on different factors. Identical and similar parts of the embodiments can be referenced to one another.

A person skilled in the art should understand that the embodiments of the present disclosure can be provided as methods, devices or computer program products. Therefore, the embodiments of the present disclosure can be complete hardware embodiments, complete software embodiments or embodiments in combination of software and hardware. Besides, the embodiments of the present disclosure can be one or more computer program products implemented in computer accessible storage media (including but not limited to magnetic disc memories, CD-ROMs, optical memories, etc.) which contain program codes for computers.

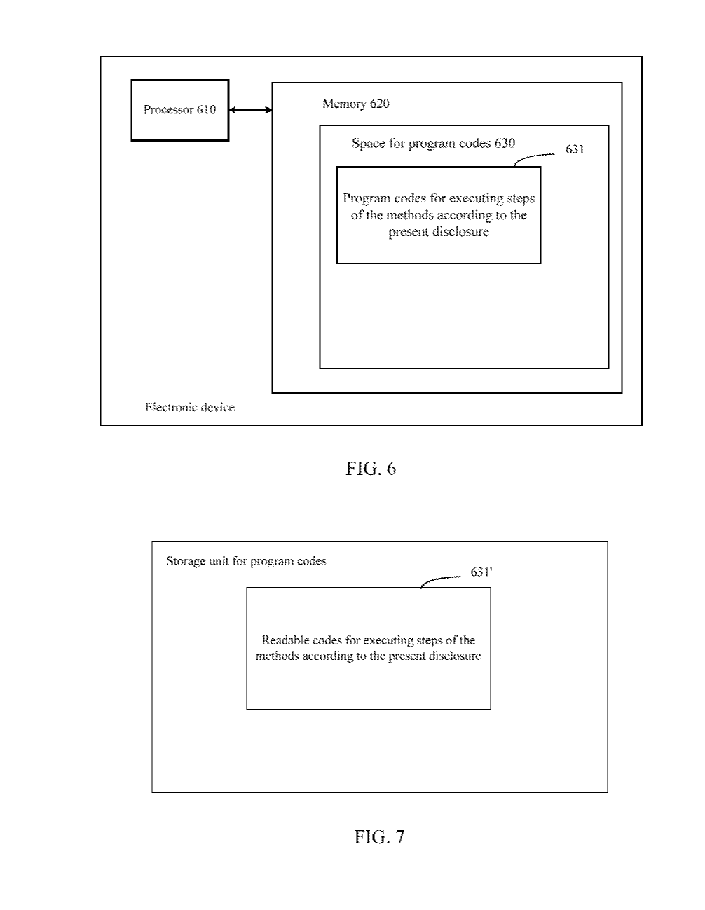

For example, FIG. 6 illustrates a block diagram of an electronic device for executing the method according the disclosure. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

The embodiments of the present disclosure are described with reference to the flowcharts and/or block diagrams of the methods and terminal devices (systems) and computer program products of the embodiments of the present disclosure. It should be understood that the computer program commands realize every process and/or block in the flowcharts and/or block diagrams, and the combination of processes and/or blocks in the flowcharts and/or block diagrams. The computer program command can be supplied to the processor of a universal computer, a special computer, an embedded processing machine or other programmable data processing terminal devices to generate a machine, so the commands executed by the processor of the computer or other programmable data processing terminal devices generate a device for realizing specific functions in one or more processes in the flowcharts and/or one or more blocks in the block diagrams.

The computer program commands can also be stored in computer readable memories which guide the computer or other programmable data processing terminal devices to work in a specific mode, so the commands stored in the computer readable memories generate products including command devices, and the command devices conduct specific functions in one or more steps in the flowcharts and/or one or more blocks in the block diagrams.

The computer program commands can also be loaded in the computer or other programmable data processing terminal devices such that the computer or other programmable processing terminal devices execute a series of operations to generate processing executed by the computer. Thus, the commands executed in the computer or other programmable terminal devices supply processes of conducting specific functions in one or more processes in the flowcharts and/or one or more blocks in the block diagrams.

Although the optimal embodiments of the present disclosure are described, a person skilled in the art can make other changes and modifications on these embodiments when understanding the basic creative concept. Therefore, the protection scope of the claims is interpreted to include the optimal embodiments and all changes and modifications which fall within the embodiments of the present disclosure.

Finally, it is needed to be noted that, in the text, the relationship terms such as the “first” and the “second” are used for merely distinguishing an entity or operation from another entity or operation, and it is not always required or hinted that the entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminals device. In the case of no more limits, the elements defined by the sentence “comprising/including a/an . . . ” should not exclude that the processes, methods, articles or terminal devices including the elements also include other identical elements.

The above are detailed descriptions of the data transfer method and data transfer device. Specific examples are used in the text to describe the principle and implementation mode of the present disclosure. The description of the above embodiments is only used for the purpose of clarifying the method and essential concepts of the present disclosure. Meanwhile, for a person skilled in the art, changes may be made to the specific implementation modes and application scope according to the concept of the present disclosure. In conclusion, the contents of the description cannot be regarded as limit in the present disclosure.

What is claimed is:

1. A data transfer method, wherein the method con rises:
at an electronic device;
receiving live data streams sent by at least two camera devices, wherein the live data streams are sent after being coded by the camera devices according to a first protocol;
performing protocol conversion on each of the live data streams and obtaining converted live data streams;
and uploading the converted data streams to a live server at the same time.

2. The method according to claim 1, wherein, performing protocol conversion on each of the live data streams comprises:
analyzing the live data streams, and encoding the analyzed live data streams according to a second protocol.

3. The method according to claim 1, wherein, uploading the converted live data streams to a live server at the same time comprises:
sending a transport request to the server by a router, wherein the transport request is used for requesting a resource uploading address for each converted live data stream;
receiving a resource address sent by the server, wherein the resource address comprises at least two resource uploading addresses;
configuring a resource uploading address for each converted data stream, and uploading the live data streams corresponding to the uploading resources addresses to the live server at the same time.

4. The method according to claim 3, wherein the resource addresses comprise a public network resource address, and the method further comprises:
sending the public network resource address to a live terminal so that the live terminal plays the live data stream corresponding to the public network resource address.

5. The method according to claim 4, further comprising:
receiving a switching request sent by the live terminal, wherein the switching request comprises a registration identifier of a target camera device;
stopping acquiring the live data stream of the current camera device according to the registration identifier of the target camera device, and switching to the target camera device to acquire the live data stream;
and feeding back the live data stream of the target camera device to the live terminal.

6. The method according to claim 1, wherein, before receiving the live data streams of at least two camera devices, the method further comprises:
receiving registration requests, sent by the camera devices, by the router, and distributing a registration identifier for each camera device according to the registration request.

7. The method according to claim 1, further comprising:
sending a control command to the camera devices, wherein the control command comprises a lifting command and/or a steering command.

8. An electronic device for data transfer, wherein the electronic device comprises:
at least one processor; and
a memory communicably connected with the at least one processor for storing instructions executable by the at least one processor, wherein execution of the instructions by the at least one processor causes the at least one processor to:
receive live data streams sent by at least two camera devices, wherein the live data streams are sent after being coded by the camera devices according to a first protocol;
perform protocol conversion on each of the live data streams and obtain converted live data streams;
upload the converted live data streams to a live server at the same time.

9. The electronic device according to claim 8, wherein,
perform protocol conversion on each of the live data streams and obtain converted live data streams comprises analyze the live data streams, and encode the analyzed live data streams according to a second protocol.

10. The electronic device according to claim 8, wherein, upload the converted live data streams to a live server at the same time comprises:
send a transport request to the server by a router, wherein the transport request is used for requesting a resource uploading address for each converted live data stream;
receive a resource address sent by the server, wherein the resource address comprises at least two resource uploading addresses;
configure a resource uploading address for each converted live data stream, and upload the live data streams corresponding to the uploading resources addresses to the live server at the same time.

11. The electronic device according to claim 10, wherein the resource addresses comprise a public network resource address, and execution of the instructions by the at least one processor causes the at least one processor to:
sending the public network resource address to a live terminal so that the live terminal plays the live data stream corresponding to the public network resource address.

12. The electronic device according to claim 11, wherein execution of the instructions by the at least one processor causes the at least one processor to:
receive a switching request sent by the live terminal, wherein the switching request comprises a registration identifier of a target camera device, stop acquiring the live data stream of the current camera device according to the registration identifier of the target camera device, and switch to the target camera device to acquire the live data stream; and feed back the live data stream of the target camera device to the live terminal.

13. The electronic device according to claim 8, wherein execution of the instructions by the at least one processor causes the at least one processor to:
receive registration requests, sent by the camera devices, by the router, and distribute a registration identifier for each camera device according to the registration request.

14. A non-transitory computer readable medium storing executable instructions that, when executed by an electronic device, cause the electronic device to:
receive live data streams sent by at least two camera devices, wherein the live data streams are sent after being coded by the camera devices according to a first protocol;
perform protocol conversion on each of the live data streams and obtain converted live data streams;
upload the converted live data streams to a live server at the same time.

15. The non-transitory computer readable medium according to claim 14, wherein, perform protocol conversion on each of the live data streams and obtain converted live data streams comprises analyze the live data streams, and encode the analyzed live data streams according to a second protocol.

16. The non-transitory computer readable medium according to claim 14, wherein, upload the converted live data streams to a live server at the same time comprises:
send a transport request to the server by a router, wherein the transport request is used for requesting a resource uploading address for each converted live data stream;
receive a resource address sent by the server, wherein the resource address comprises at least two resource uploading addresses;
configure a resource uploading address for each converted live data stream and upload the live data streams corresponding to the uploading resources addresses to the live server at the same time.

17. The non-transitory computer readable medium according to claim 16, wherein the resource addresses comprise a public network resource address, and execution of the instructions by the at least one processor causes the at least one processor to:
sending the public network resource address to a live terminal so that the live terminal plays the live data stream corresponding to the public network resource address.

18. The non-transitory computer readable medium according to claim 17, wherein execution of the instructions by the at least one processor causes the at least one processor to:
receive a switching request sent by the live terminal, wherein the switching request comprises a registration identifier of a target camera device, stop acquiring the live data stream of the current camera device according to the registration identifier of the target camera device, and switch to the target camera device to acquire the live data stream; and feed back the live data stream of the target camera device to the live terminal.

19. The non-transitory computer readable medium according to claim 14, wherein execution of the instructions by the at least one processor causes the at least one processor to:
receive registration requests, sent by the camera devices, by the router, and distribute a registration identifier for each camera device according to the registration request.

20. The non-transitory computer readable medium according to claim 14, wherein execution of the instructions by the at least one processor causes the at least one processor to:
send a control command to the camera devices, wherein the control command comprises a lifting command and/or a steering command.
